(19) United States
(12) Patent Application Publication
(10) Pub. No.: US 2014/0161550 A1
(43) Pub. Date: Jun. 12, 2014

(54) Micro-Drill and Method for Manufacturing the Same

(71) Applicant: National Tsing Hua University, Hsinchu (TW)

(72) Inventors: Nyan-Hwa TAI, Hsinchu (TW); Ting-Hsun CHANG, Hsinchu (TW)

(73) Assignee: National Tsing Hua University, Hsinchu (TW)

(21) Appl. No.: 14/102,286

(22) Filed: Dec. 10, 2013

(30) Foreign Application Priority Data
Dec. 11, 2012 (TW) 101146598

(51) Int. Cl. B23B 51/02

(52) U.S. Cl. CPC B23B 51/02
USPC 408/144; 204/486

(57) ABSTRACT

A micro-drill and a method for manufacturing the same are disclosed. The micro-drill comprises: a substrate having a surface, an ultra-nanocrystalline diamond film including a plurality of ultra-nanocrystalline diamond grains, which is formed on the surface of the substrate; wherein the substrate is a tungsten carbide substrate and a size of each ultra-nanocrystalline diamond grain is in a range from 1 to 30 nm.

### CROSS REFERENCE TO RELATED APPLICATION

This application claims the benefits of the Taiwan Patent Application Serial Number 101146598, filed on Dec. 11, 2012, the subject matter of which is incorporated herein by reference.

### BACKGROUND OF THE INVENTION

1. Field of the Invention

The present invention relates to a micro-drill and a method for manufacturing the same. More particularly, the present invention relates to a micro-drill with an ultra-nanocrystalline diamond film formed on a surface thereof and a method for manufacturing the same.

2. Description of Related Art

In a semiconductor manufacturing process, a drilling process is often performed on a multilayer circuit board to form conductive through holes or conductive vias which provide electrical connections between layers. In the drilling process of the semiconductor manufacturing process, a micro-drill is usually selected to form electric contacts for chips or circuits for the semiconductor device with small size. Ordinary, the micro-drill becomes blunt and deformed after multiple uses resulting in poor drilling accuracy and undesirable surface roughness in pore. Furthermore, micropores are required for the semiconductor device with high integration and miniaturization, but the micro-drill with small size for manufacturing the same is always ruptured during the manufacturing process thereof. Therefore, it is necessary to replace the micro-drill appropriately to ensure the pore quality while drilling. In addition, the lifespan of the micro-drill is highly related to the manufacturing cost thereof.

The micro-drill is usually made of material having high hardness and high abrasive resistance, for example, diamonds, stainless steel, tungsten carbide and so on. Especially, tungsten carbide has advantages of high hardness, high operation temperature, low thermal expansion coefficient, and high chemical stability, which is a proper material for the micro-drill. In order to increase the lifespan of the micro-drill, it was developed to coat the micro-drill made of tungsten carbide with microcrystalline diamond.

In order to form the micro-, nano-, or ultra-nano crystalline diamond film, a nucleation process has to be performed on an objective in advance. Among the conventional nucleation processes, the traditional nucleation process using ultrasonic scratching treatment can form diamond nuclei quickly, but the physical property of substrate may be deteriorated due to the scratches formed on the substrate, for instance, the micro-drill may be damaged during the ultrasonication process. Currently, a polycrystalline diamond film is generally grown through a chemical vapor deposition (CVD) process. In the CVD process, a gas mixture comprising argon, hydrogen, oxygen, nitrogen, hydrocarbon or other organic carbon-containing material using as a precursor material is channeled into the reactor and decomposed to deposit carbon species onto the substrate for forming a polycrystalline diamond film. Herein, microwave plasma enhanced chemical vapor deposition (MPECVD) is a method by introducing one or more reactants into a chamber and ionizing the reactants; subsequently, the ionized carbon species were deposited onto the non-diamond substrate to form an ultra-nanocrystalline diamond film

The substrate damaged by using the aforementioned ultrasonication process can be alleviated when the electrophoresis method developed herein was adopted. Until now, a micro-drill coated with an ultra-nanocrystalline diamond film having even surface, high hardness, and good abrasion resistance has not been developed, and it is imperative for manufacturing the small-sized semiconductor device.

### SUMMARY OF THE INVENTION

An objective of the present invention is to manufacture a micro-drill with an ultra-nanocrystalline diamond film formed on a surface thereof

Another objective of the present invention is to provide a method for growing an ultra-nanocrystalline diamond film on the micro-drill to coat a surface of the micro-drill with an ultra-nanocrystalline diamond film without damaging the micro-drill.

To achieve the objective, the micro-drill of the present invention includes a substrate having a surface, and an ultra-nanocrystalline diamond film including a plurality of ultra-nanocrystalline diamond grains formed on the surface of the substrate; wherein the substrate is a tungsten carbide substrate and a size of each ultra-nanocrystalline diamond grain is in a range from 1 to 30 nm. Preferably, the size of each ultra-nanocrystalline diamond grain is in a range from 1 to 10 nm; and more preferably, the size of each ultra-nanocrystalline diamond grain is in a range from 2 to 5 nm.

The present invention also provides a method for manufacturing a micro-drill, comprising the following steps: providing a substrate and nanodiamond powders, wherein the substrate is a tungsten carbide substrate; pretreating the nanodiamond powders with an acid and adding the treated nanodiamond powders into a solvent to form a suspension, and immersing the substrate into the suspension followed by the electrophoresis process. The substrate is used as an anode accompanying with a stainless steel as cathode to form a plurality of nuclei on the substrate. Subsequently, a chemical vapor deposition was performed on the substrate with a plurality of nuclei formed thereon to form an ultra-nanocrystalline diamond film on the substrate.

On the micro-drill of the present invention, the root mean square surface roughness (Rᵣₘₛ) of the ultra-nanocrystalline diamond film is not particularly limited. Preferably, the Rᵣₘₛ thereof is in a range from 10 to 40 nm; and more preferably, the Rᵣₘₛ thereof is in a range from 20 to 40 nm. Compared with the conventional microcrystalline diamond film, the diamond grains included in the ultra-nanocrystalline diamond film of the present invention have smaller sizes and round shapes without sharp corners and edges. Moreover, the ultra-nanocrystalline diamond film of the present invention has the lower root mean square surface roughness (Rᵣₘₛ) and higher nuclei density. Therefore, though the surface of the substrate is uneven; the ultra-nanocrystalline diamond film conformally formed thereon still reveals uniform and smooth distribution.

Besides, the Raman spectrum of the ultra-nanocrystalline diamond film has four characterized peaks: a D-band at 1300-1400 cm⁻¹ (about 1350 cm⁻¹), a G-band at 1530-1630 cm⁻¹ (about 1580 cm⁻¹), and two peaks at 1090-1190 cm⁻¹ (about 1140 cm⁻¹) and 1430-1530 cm⁻¹ (about 1480 cm⁻¹), which are contributed to the carbon-hydrogen bonds presented in the boundaries of the crystal grains. In other words, the ultra-nanocrystalline diamond film of the present invention does not have the characterized peak representing the sp³ bonded carbon (1332 cm⁻¹), but has those representing the υ₁-band (1140 cm⁻¹) and υ₃-band (1480 cm⁻¹) of trans-polyacetylene. These characterized peaks indicate that the carbon-hydrogen bonds are formed along the boundaries of the crystal grains, and the peak intensities of υ₁-band and υ₃-band in the ultra-nanocrystalline diamond film of the present invention are more significant than those of the conventional microcrystalline diamond film. Hence, the result indicates that the ultra-nanocrystalline diamond film of the present invention mostly composed of nanodiamond grains rather than microcrystalline diamonds, and as a result, shown excellent quality.

Furthermore, the surface configuration of the substrate is not limited and it can be a flat surface or an irregular surface. While the substrate has an irregular surface, an ultra-nanocrystalline diamond film can be effectively grown on the substrate through the method for growing the ultra-nanocrystalline diamond film of the present invention. In other words, the method for growing the ultra-nanocrystalline diamond film of the present invention is not limited to a specific configuration of the substrate and is easy to be operated for wide application. Moreover, if the substrate is a tungsten carbide substrate containing cobalt (Co) in the grain boundaries which may cause the growth of the diamond film to be inhibited; therefore, a pretreatment for removing the cobalt before deposition of the ultra-nanocrystalline diamond film is imperative. The method for removing the cobalt can be any known method used in the art, for example, a treatment using a solution containing sulfuric acid (H₂SO₄) and hydrogen peroxide (H₂O₂).

According to the method for manufacturing the micro-drill of the present invention, the objective of acid treatment is to positively charged the nanodiamonds; therefore, the acid used to treat the nanodiamond powders is not particularly limited. Preferably, the acid is at least one selected from a group consisting of nitric acid, hydrochloric acid, sulfuric acid, phosphoric acid and acetic acid.

In addition, the solvent used in the present invention can be any solvent generally used in the art. After the nanodiamond powders are treated with the acid, the treated nanodiamond powders are added into the solvent to form a suspension, wherein a concentration of the nanodiamond powders therein is preferably in a range from 0.05 g/l to 0.15 g/1; but the present invention is not limited thereto. In the present invention, the concentration of the nanodiamond powders in the suspension can be adjusted by a skilled person in the art based on the required nuclei density of the nanodiamond on the substrate.

According to the method for manufacturing the micro-drill of the present invention, a plurality of nuclei are formed on the substrate through an electrophoresis process to further grow ultra-nanocrystalline diamond grains thereon, and therefore the substrate surface can be prevented from being damaged. During the electrophoresis process, the non-uniform distribution of electric fields is resulted from the irregular surface of the substrate. To solve this problem, the electrophoretic parameters such as applied voltage, current, time, and apparatus can be controlled by a skilled person in the art. Furthermore, the shape of the counter cathode is also an important factor to improve the uniformity of the formed ultra-nanocrystalline diamond film. Preferably, the cathode used in the electrophoresis process has a tubular shape.

In the present invention, the routes for performing the chemical vapor deposition process is not limited; any general method for growing diamonds can be applied to the present invention, for example, plasma enhanced chemical vapor deposition and hot-filament chemical vapor deposition. Preferably, a microwave plasma chemical vapor deposition is performed to grow the ultra-nanocrystalline diamond film in the present invention. In the chemical vapor deposition process used in the present invention, gas mixture in the reaction chamber may include inert gas such as argon and carbon-containing gas such as methane. Herein, the carbon-containing gas contained in the gas mixture may be 0.1 to 10% by volume, and preferably is 0.8 to 5% by volume. The nucleation process of the carbon-containing gas on the substrate may be carried out at 200 to 1000° C., and preferably at 475° C. Furthermore, the pressure may be maintained in the range from 50 to 300 Torr, and preferably from 110 to 150 Torr during the deposition process. However, all conditions described above can be modified by a skilled person in the art.

In the present invention, the ultra-nanocrystalline diamond film is deposited in Ar atmosphere containing 1.0 Vol.% of CH₄. During the deposition process of the ultra-nanocrystalline diamond film, the concentration of hydrogen is extremely low, which results in low etching rate of the ultra-nanocrystalline diamond grain boundaries; as a result, form secondary nucleations for obtaining diamond grains in nanometer scale. Compared with the conventional hydrogen-abundant nucleation method, the present invention has the advantage of low-temperature process due to low-power input, inducing low concentrations of ionized inert gas (i.e. argon) and hydrogen atoms obtained from decomposition of methane. More specifically, both the low microwave power and the low heat generation due to recombination of low concentration hydrogen atoms lowered the temperature of the substrate. As a result, nuclei can be formed on the substrate under the low temperature process, which is economic and can be applied to the low temperature substrate for synthesizing diamond film. In some other circumstance, low concentration hydrogen can be introduced into the chamber to obtain the ultra-nanocrystalline diamond film with larger crystal grains.

Compared with the conventional method for growing the diamond film, which needs heat-treating and coarsening the substrate and requests metal ions in the electrolyte during the co-electroplating process. Whereas, the present invention can be performed for growing the ultra-nanocrystalline diamond film using the electrophoresis process without aforementioned restricts. Therefore, the process for growing the ultra-nanocrystalline diamond film can be simplified by using the method of the present invention. Hence, the micro-drill coated with the ultra-nanocrystalline diamond manufactured through the method of the present invention can enhance the hardness and the abrasive resistance, therefore improve the cutting capability, increase the drilling accuracy, and reduce the drill deterioration. Consequently, the method for manufacturing the micro-drill coated with the ultra-nanocrystalline diamond film of the present invention can be adopted by the industry for manufacturing micro-drill hard materials such as fine ceramics, integrated circuits, precious stones, jades, magnetic heads for MR and GMR, hard drive drivers, quartz plates, hard alloy, and optical lens. In addition, high machining efficiency, long lifespan, and high polishing surface of the drilled holes can be achieved when the present invention is used.

Other objectives, advantages, and novel features of the invention will become more apparent from the following detailed description when taken in conjunction with the accompanying drawings.

### BRIEF DESCRIPTION OF THE DRAWINGS

FIG. 1 is a photograph of a tool carrier for depositing an ultra-nanocrystalline diamond film on a substrate of the Example 1 of the present invention;

FIG. 2 is a SEM image of an ultra-nanocrystalline diamond film of Example 1 of the present invention;

FIG. 3 is an AFM image of an ultra-nanocrystalline diamond film of Example 1 of the present invention;

FIG. 4 is a Raman spectrum of an ultra-nanocrystalline diamond film of Example 1 of the present invention;

FIG. 5 is a SEM image of a microcrystalline diamond film of Comparative Example 1 of the present invention;

FIG. 6 is an AFM image of a microcrystalline diamond film of Comparative Example 1 of the present invention; and

FIG. 7 is a Raman spectrum of a microcrystalline diamond film of Comparative Example 1 of the present invention.

### DETAILED DESCRIPTION OF THE PREFERRED EMBODIMENT

The present invention has been described in an illustrative manner, and it is to be understood that the terminologies used in the description are intended to be in the nature of description rather than of limitation. Many modifications and variations of the present invention are possible in light of the above teachings. Therefore, it is to be understood that within the scope of the appended claims, the invention may be practiced otherwise than as specifically described.

### Example 1

### Preparation of an Ultra-Nanocrystalline Diamond Film

A micro-drill made of tungsten carbide (WC) containing cobalt in the grain boundaries, which is pretreated using a mixture of sulfuric acid (H₂SO₄) and hydrogen peroxide (H₂O₂) to remove the cobalt from the surface of the tungsten carbide substrate. Besides, nanodiamond powders (single-digit nanodiamonds, SDND; Plasma Chem) are also pretreated with hydrochloric acid to positively charge the nanodiamond powders. Next, the nanodiamond powders are introduced into deionized water, forming a suspension with a concentration of 0.1 g/l.

Next, the substrate is immersed into the suspension and a bias of −20 V is applied to anode for 10 to 60 seconds to create nucleation sites thereon. Then, a plurality of nuclei are formed on the substrate through an electrophoresis process, wherein the substrate is served as an anode and is inserted into a tubular-shape counter electrode made of stainless steel which is served as a cathode.

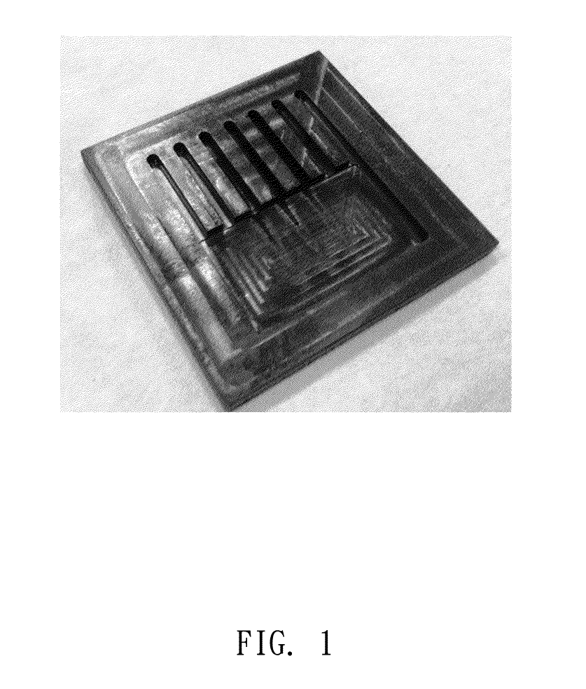

Finally, the ultra-nanocrystalline diamond film is deposited through a microwave plasma enhanced chemical vapor deposition (MPECVD) process (IPLAS-Cyrannus) in Ar atmosphere containing 1 Vol.% of CH₄. The pressure, flow rate and power are maintained at 120 Torr, 100 sccm and 1200 W, respectively. The growth process is carried out at a relatively low temperature (<475° C.) for 120 minutes. The micro-drill coated with an ultra-nanocrystalline diamond film is manufactured thereof. In order to enhance the adhesion of the ultra-nanocrystalline diamond film on the micro-drill, the drill is fixed in a fixture to prevent it from contacting with the holder during the deposition process, as shown in FIG. 1.

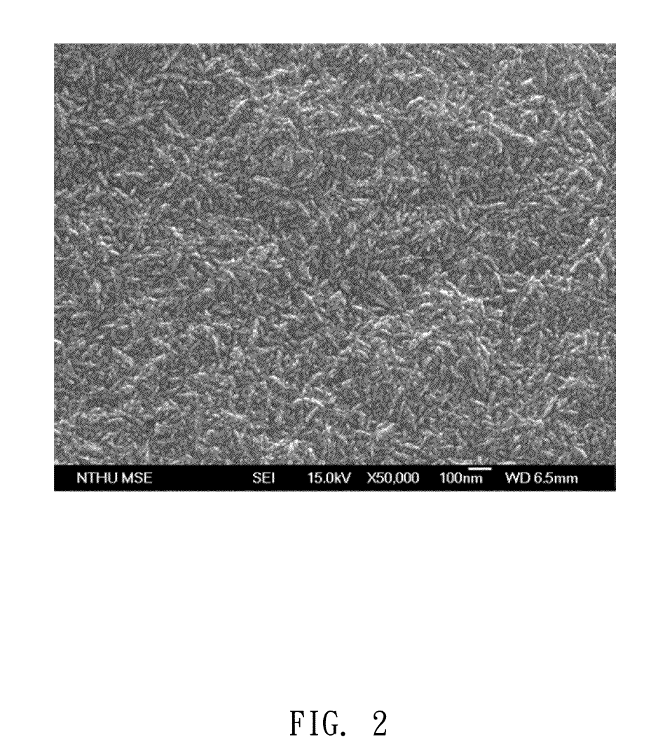

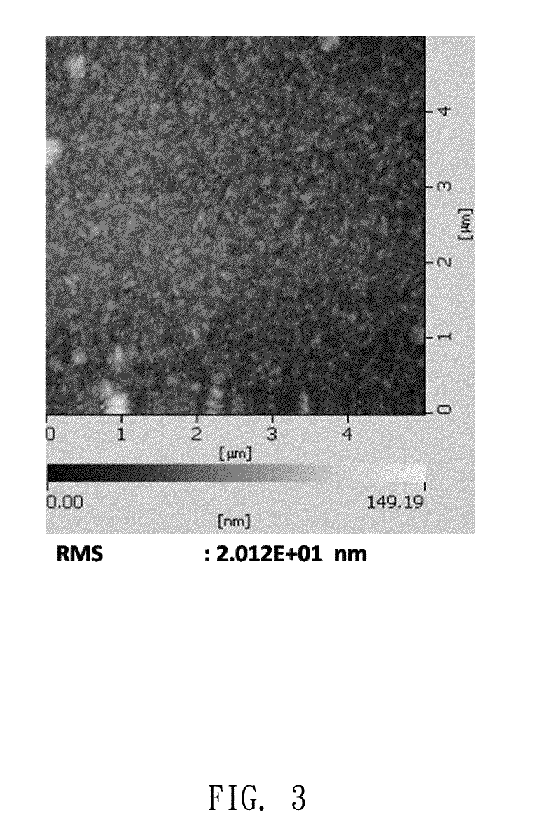

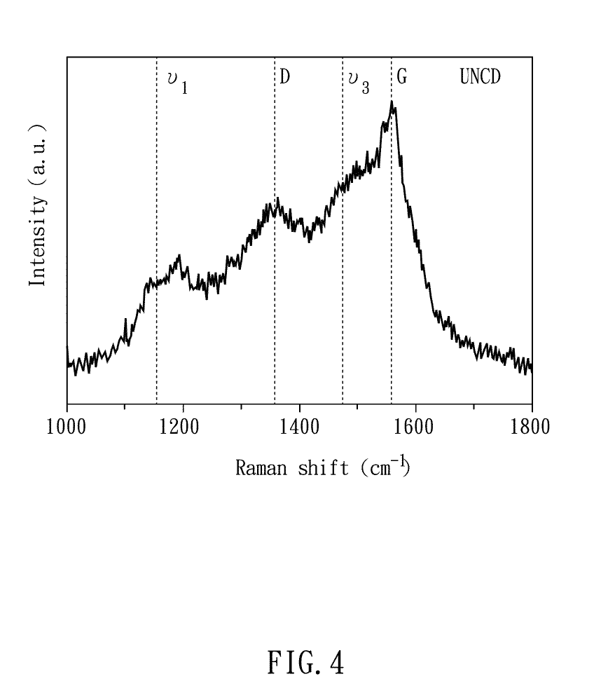

The scanning electron microscope (SEM) image of the micro-drill surface coated with an ultra-nanocrystalline diamond film is depicted in FIG. 2, shown that the crystal grains of the ultra-nanocrystalline diamond film possess small sizes and round shapes without corners and edges. FIG. 3 shows the atomic force microscope (AFM) image, indicating that uniform and smooth distribution of the ultra-nanocrystalline diamond grains are formed on the micro-drill surface. Based on the result shown in FIG. 3, the root mean square surface roughness (Rᵣₘₛ) of the ultra-nanocrystalline diamond film is about 20 nm, implying high nuclei density of the film. FIG. 4 is a Raman spectrum of the ultra-nanocrystalline diamond film examined using a Raman spectroscopy (Renishaw) equipped with a 514 nm laser as an excitation source. Referring to FIG. 4, four typical characterized peaks of the ultra-nanocrystalline diamond are observed: a D-band at approximate 1350 cm⁻¹, a G-band at approximate 1580 cm⁻¹, and two peaks at approximate 1140 cm⁻¹ and 1480 cm⁻¹ which are correlated to the carbon-hydrogen bonds presented in the grain boundaries. The peak intensity of G-band at approximate 1580 cm⁻¹ is stronger than that of the D-band at approximate 1350 cm⁻¹.

### Comparative Example 1

### Preparation of a Microcrystalline Diamond Film

Briefly, the microcrystalline diamond film is deposited by a microwave plasma enhanced chemical vapor deposition (MPECVD) process (IPLAS-Cyrannus) in Ar atmosphere containing 1 Vol.% of CH₄. The pressure, flow rate, and power are maintained at 50 Torr, 100 sccm and 1600 W, respectively. The growth process is carried out at 700° C. for 120 minutes.

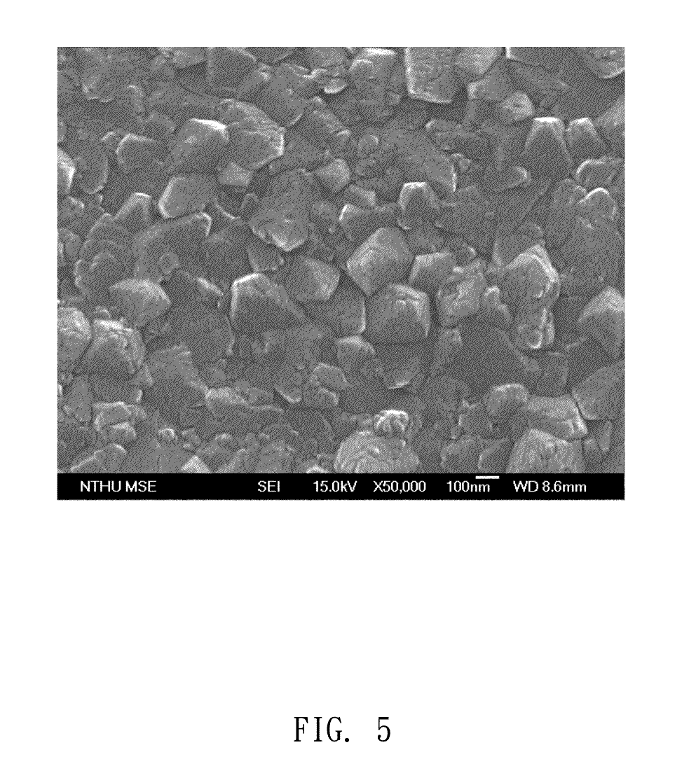

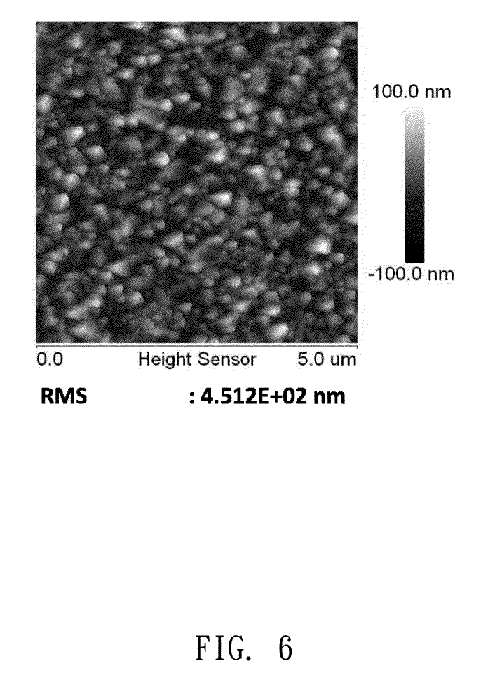

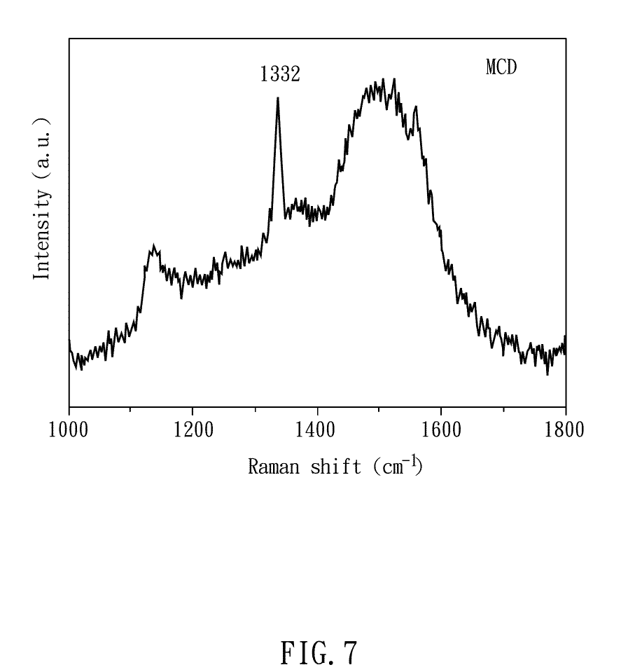

The obtained microcrystalline diamond film is examined using scanning electron microscope (SEM), and the SEM image shown in FIG. 5 depicts that the crystal grains of the microcrystalline diamond film have sharp corners and edges with larger size. FIG. 6 shows the atomic force microscope (AFM) image thereof, indicating that non-uniform distribution of the microcrystalline diamond grains are formed on the surface of the micro-drill. Based-on the result shown in FIG. 6, the root mean square surface roughness (Rᵣₘₛ) of the microcrystalline diamond film is about 451 nm. In addition, FIG. 7 is a Raman spectrum of the microcrystalline diamond film examined with a Raman spectroscopy (Renishaw) equipped with a 514 nm laser as an excitation source. Referring to FIG. 7, a significant peak at 1332 cm⁻¹ illustrates the presence of diamond grains, while shift of the G-band from 1580 cm⁻¹ to approximate 1500 cm⁻¹ and obscure D-band at 1350 cm⁻¹ are observed.

Although the present invention has been explained in relation to its preferred embodiment, it is to be understood that many other possible modifications and variations can be made without departing from the spirit and scope of the invention as hereinafter claimed.

What is claimed is:

1. A micro-drill, comprising:
a substrate having a surface; and
an ultra-nanocrystalline diamond film including a plurality of ultra-nanocrystalline diamond grains, and formed on the surface of the substrate;
wherein the substrate is a tungsten carbide substrate and a size of each ultra-nanocrystalline diamond grain is in a range from 1 to 30 nm.

2. The micro-drill as claimed in claim 1, wherein a root mean square surface roughness (Rᵣₘₛ) of the ultra-nanocrystalline diamond film is in a range from 10 to 40 nm.

3. The micro-drill as claimed in claim 1, wherein a Raman spectrum of the ultra-nanocrystalline diamond film has four characterized peaks, which are a D-band at 1300-1400 cm⁻¹, a G-band at 1530-1630 cm⁻¹, and two peaks at 1090-1190 cm⁻¹ and 1430-1530 cm⁻¹.

4. The micro-drill as claimed in claim 1, wherein a size of each ultra-nanocrystalline diamond grain is ranging from 1 to 10 nm.

5. The micro-drill as claimed in claim 1, wherein the micro-drill is manufactured by a method comprising the following steps:
providing a substrate and nanodiamond powders, wherein the substrate is a tungsten carbide substrate;
pretreating the nanodiamond powders with an acid followed by adding the treated nanodiamond powders into a solvent to form a suspension;
immersing the substrate into the suspension;
performing an electrophoresis process on the substrate acted as an anode accompanying with a cathode to form a plurality of nuclei on the substrate; and
performing a chemical vapor deposition to deposit a plurality of nuclei formed thereon to form an ultra-nanocrystalline diamond film on the substrate.

6. The micro-drill as claimed in claim 5, wherein the substrate has an irregular or smooth surface.

7. The micro-drill as claimed in claim 5, wherein the cathode used in the electrophoresis has a tubular shape.

8. The micro-drill as claimed in claim 5, wherein the substrate is a tungsten carbide substrate containing cobalt in the grain boundaries, and a pretreatment for removing the cobalt is performed on the substrate before immersing the substrate into an acid solution.

9. The micro-drill as claimed in claim 5, wherein a concentration of the nanodiamond powders in the suspension is in a range from 0.05 g/l to 0.15 g/l.

10. The micro-drill as claimed in claim 5, wherein the acid is at least one selected from a group consisting of nitric acid, hydrochloric acid, sulfuric acid, phosphoric acid and acetic acid.
